(19) United States
(12) Patent Application Publication
(10) Pub. No.: US 2008/0272034 A1
(43) Pub. Date: Nov. 6, 2008

(54) Separation of particles from a fluid by wave action

(75) Inventors: Bran Ferren, Beverly Hills, CA (US); W. Daniel Hillis, Encino, CA (US); Elizabeth A. Sweeney, Seattle, WA (US); Lowell L. Wood, Livermore, CA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC,

(21) Appl. No.: 12/080,877

(22) Filed: Apr. 7, 2008

Related U.S. Application Data
(63) Continuation-in-part of application No. 10/919,077, filed on Aug. 16, 2004, now abandoned.

(51) Int. Cl. B01D 43/00; B01D 36/00

(52) U.S. Cl. 210/96.1

(57) ABSTRACT

Methods and apparatuses for the separation of particles in a fluid provide for a container to enclose the fluid mixture containing particles and at least one transducer to create a wave action within the fluid. A gradient driver may be included to increase the particle separation. Inlet ports may be attached to add additional components or fluid to the mixture and outlet ports may be attached to remove the separated particles.

### TECHNICAL FIELD

The present application relates, in general, to methods and apparatuses for separating particles from a fluid mixture.

### BACKGROUND

Currently there are a number of techniques available to separate particles from a fluid mixture. Particle separation processes are useful in a number of contexts, including large scale purification of contaminants from water systems, the extraction of components from medical specimens and the detection of particular components in a fluid mixture. There are separation methods currently in use that are based on the physical size of the particles to be separated relative to the size of other components of the mixture or the movement of particles when they are subjected to gravitational pressure.

One approach that has been commonly used for the separation of particles from a fluid mixture is screening or filtering to remove particles based on their physical size. Screening and filtering systems have been particularly used in the field of water purification, both in order to remove macroscopic contaminants from wastewater during treatment as well as in the removal of microscopic organisms from water in order to make it potable. Filtering systems are also used to remove particles from gaseous fluids. A filtering system relates to both the size of the components in the mixture to be filtered as well as the size of the particles to be removed. In many situations, a filtering or screening approach will lose effectiveness when the particles to be removed are larger in size than any particles that are desired to be retained in the fluid. A filter or screening material of an appropriate strength and durability may have limitations with respect to the size and shape pore available to retain the desired particles on one side of the filter while allowing the fluid to flow through. In addition, the physical pressure of retaining the particle on one side of the filter may cause damage to the particle. One example of this is filtering whole blood to remove the component cells, which can cause lysis of relatively fragile blood cells.

Another approach that has been used to separate particles from a fluid mixture is dialysis. In this method, the mixture is enclosed in a semipermeable material that restricts dispersion of the particles of interest but allows for the diffusion of other components of the mixture. The enclosure is then placed into a fluid with the appropriate characteristics to encourage diffusion of the undesired mixture components out of the enclosure. Dialysis has been historically used in biological contexts, particularly to purify proteins from associated salts in a liquid mixture. Dialysis may be limited to situations where there is an appropriate material available to enclose the mixture and to allow diffusion of the undesired components. Since dialysis relies on diffusion into an excess of the diffusion fluid, it may not be conducive to large scale purification applications in some situations due to size constraints. In addition, since the diffusion process is often slow and inefficient, dialysis is typically used in situations that are not time sensitive and where the separated particles are not labile in the given conditions. Dialysis also results in the particles being retained in a fluid mixture, which may not be adequate purification for a particular situation.

Centrifugation has also been used to separate particles from a fluid mixture. In centrifugation, the fluid mixture is rotated to separate out components of the mixture based on their size, shape and density as well as the viscosity of the fluid and the rotor speed. Centrifugation separates particles based on their size, shape and density within the mixture. Centrifugation also puts the particles under some stress due to the physical force from the rotation, which may not be acceptable in all circumstances. Centrifugation is commonly used to separate biological particles such as cells, cellular organelles, viruses, proteins and large nucleic acids from liquid mixtures. It is also used to remove contaminants during water purification.

Another approach to separation of particles from a fluid mixture is the removal of particular components indirectly based on their binding to a secondary agent, followed by the removal of the secondary agent and the particle complex. One application for this technique is in the remedial purification of seawater after an oil spill. In that situation, absorbent material is applied to the surface of seawater in order to absorb the oil and then the material with the absorbed oil is removed. Another version of this approach is in the purification of specific biological particles from a mixture by means of magnetic beads where the particle of interest is specifically bound to magnetic beads and the bead-particle complex is then removed by magnetic force.

### SUMMARY

In some aspects, what is described includes but is not limited to an apparatus for separating particles from a fluid comprising a container capable of enclosing the fluid mixture and one or more transducers coupled to the container and operable to produce a wave or waves within the fluid mixture, the wave function being of a wavelength and amplitude corresponding to a physical characteristic of the particles, the wave function being of a type that produces spatial distribution of the particles within the container. The wave or waves may be of any type, including electric, magnetic, pressure or acoustic and may be either standing or traveling. An electric controller may be included as part of the system to provide an input signal to the one or more transducers. The electric controller may be a signal generator. In other aspects a binding material may be bound to the particles to create a composite of the particles and the binding material, in which case the wave may correspond to a physical characteristic of the particles, the binding material or the composite of both. In other aspects, a gradient generator is attached to the side of the container which creates a gradient driver at any angle relative to the wave function to further separate the particles. The gradient driver may be of any type, including an electric, magnetic, pressure or acoustic field or an optical or thermal gradient. The gradient may be linear or nonlinear. One or more inlet ports may also be attached to the container, or the container may be permeable, to allow additional fluid or mixture components to enter the container enclosure. One or more outlet ports may be attached to the container to allow portions of the separated particles to exit the container. In some aspects, the inlet and/or outlet ports may be attached to the electrical controller, which may regulate material being added to or exiting from the container. Sensor and/or collection devices of any type may be coupled to the outlet ports in any combination or series, and these devices may also be coupled to the electronic controller. Data from the sensor and/or controller devices may be used to modify the wave and/or gradient generator.

In one aspect, a method is described which includes but is not limited to a method for separating particles from a fluid by means of non-acoustic wave action within the fluid and controlling the wave action by means of an attached device. A binding material may be attached to the particles, and the wave action may be a function of the particles, the binding material or a composite of both. Also described is the addition of a gradient driver, which may be at any angle relative to the wave and may be of any type, including magnetic, electrostatic, acoustic, optical or thermal. The gradient driver may be linear or nonlinear. In some aspects, components of the mixture or fluid may be added through inlet ports, more materials may enter through a permeable container or no additional components might be added. In some aspects, separated particles may exit the container through outlet ports, through a permeable container, or the separated material may not be removed from the container in which the separation is carried out. The particles may also be collected or physical characteristics of the particles may be detected after the particles exit the container. The collection or detection of physical characteristics may happen in any series or combination. In some aspects, data from the collection and/or detection may be used to modify the wave and/or gradient driver.

In addition to the foregoing, various other method, apparatus and system aspects are set forth and described in the text (e.g., claims and detailed description) and drawings of the present application. The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein.

### BRIEF DESCRIPTION OF THE DRAWINGS

The use of the same symbols in different drawings typically indicates similar or identical items.

FIG. 1 is a simplified view of a particle separator constructed in accordance with one embodiment;

FIG. 2 is a view of the embodiment as shown in FIG. 1 with the wave activity in the progress of separating the particles;

FIG. 3 is another simplified view of an embodiment of a separator apparatus system, including inlet and outlet ports attached to the container, a sensor device connected to an outlet port, and a collection device attached to an outlet port;

FIG. 4 is another simplified representation of an embodiment of a particle separator, including binding material attached to the particles being separated;

FIG. 5 is a simplified view of a particle separator including a gradient driver;

FIG. 6 is a simplified depiction of an embodiment of a particle separator including two transducers attached to the container, the two transducers together creating a standing wave within the container.

### DETAILED DESCRIPTION

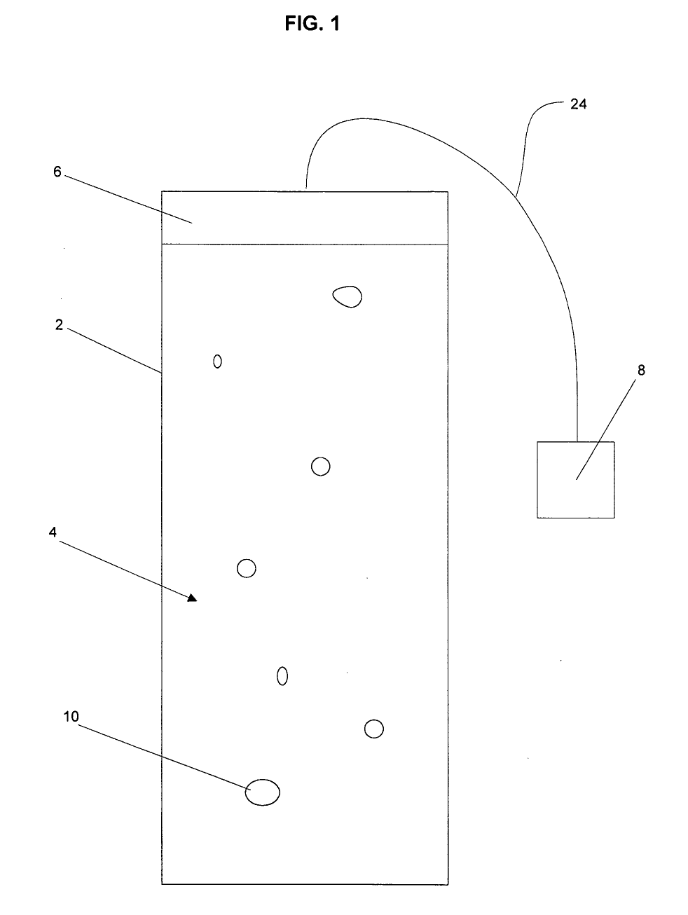

Depicted in FIG. 1 is an electro-mechanical system comprising a container 2 enclosing a fluid mixture 4 which contains particles 10. The container 2 may be constructed from any type or a combination of materials, including plastics, metal, glass, polysaccharides or membrane in order to enclose a liquid or fluid gaseous mixture 4 which includes particles 10. The enclosure of the container 2 may be nonpermeable so as to not admit any new components to the mixture, or may be permeable to allow some components of the fluid mixture and/or additional fluid to enter or exit from the container enclosure boundary.

The particles 10 may be of any type, including organic, chemical, metallic or biological, or a combination of any number or type of these. If the particles are biological, they may include proteins, nucleic acids, cells, antibodies, viruses or other types of biological particles singly or in any combination. The term “particles” is not necessarily limited to individual atoms, molecules, or organisms. In some cases, for example, particles may refer to groups of atoms or molecules of similar or different types.

As used herein, separation typically applies to isolating or otherwise differentiating individual particles or groups of particles from each other. In some cases, the separation may be spatial separation. The spatial separation may be along a common axis or into another spatial configuration. Typically, but not always, the separation is a function of the characteristics of the particles.

In many cases the particles include more than one type. They may include particles of similar types having differing characteristics. For example, the particles may be various proteins having differing weights and the wave pattern may be selected to isolate the particles of a first weight from the particles of a second weight. In other approaches, the particles may be of different types. For example, the particles may include conductive molecules and non-conductive molecules. In such a case, the wave pattern may be selected isolate conductive particles from non-conductive particles. Such an approach may utilize non-acoustic wave patterns as described below.

The container 2 may be of any size and shape appropriate to the particular embodiment, and may be either reusable indefinitely or disposable after one or a limited number of uses. The container 2 may be of a type that encloses the fluid mixture 4 from an external environment which is primarily air or liquid or one which encloses a fluid mixture 4 within a larger structure such as a fluid bath, gaseous or other type of chamber. The fluid mixture 4 may be composed of liquids or gasses containing inorganic or organic components singly or in combination in addition to the particles 10. The particles 10 may be of any type, including metallic, organic or inorganic compounds, and may include biological components such as proteins, peptides, nucleic acids, antibodies, cells or viruses or a combination of any number and types of these.

Attached or otherwise coupled to the container 2 is at least one transducer 6 which is capable of creating a wave action within the fluid mixture 4 enclosed by the container 2. The transducer 6 may be one of a number of types, including ones that generate waves electrically, piezoelectrically, acoustically, or magnetically. More generally, the transducer may be of any type that converts input energy of one form into output energy of another form.

In one approach, the transducer 6 is a piezoelectric transducer mounted on an exterior wall of the container. In another approach the transducer 6 is an electromagnetic-acoustic transducer that may be positioned outside or inside of the container. Such transducers need not be in physical contact with the actual container to produce waves. For example, some forms of transducers may use fields generated outside of the container to produce eddy currents that, in turn, produce particle movement inside of the container.

A variety of other approaches to producing waves within the fluid or providing a driving wave pattern that affects the particles in the fluid may be implemented. For example, an electromagnetic field pattern can be formed in the container and can produce a standing or traveling field that can separate or drive the particles. In a simplified case where the particles are ferrous or otherwise magnetically responsive, the wave pattern may be generated by a magnetic field generator, such as an array of conductors carrying controlled currents.

The transducer 6 may be coupled through conduit 24 to an electronic controller 8. The electronic controller may also include a signal generator that provides a driving signal to the transducer 6. In the embodiment shown in FIG. 1, a single transducer 6, attached to one end of a cylindrical container 2, is capable of creating a wave axially along the length of the cylindrical container.

In some embodiments, multiple transducers can be positioned to create wave patterns in a variety of types or characteristics according to known wave pattern generation techniques. In some cases, the complexity or resolution of the wave pattern may be defined by the number, position, frequency and other characteristics of the transducers.

In more complex cases, electric fields or optical waves from the transducers can be interfered, similarly to holographic interference techniques, to produce a fixed or controllably moving wave pattern. Where the particles or the fluid material are of types that interact with the wavelength or other characteristics of the fields or waves, the fields or waves can provide motive force to move or separate the particles.

The structures and characteristics for generating of substantially arbitrary wave patterns can be derived analytically using known relationships, determined empirically, determined using finite element techniques or other known approaches.

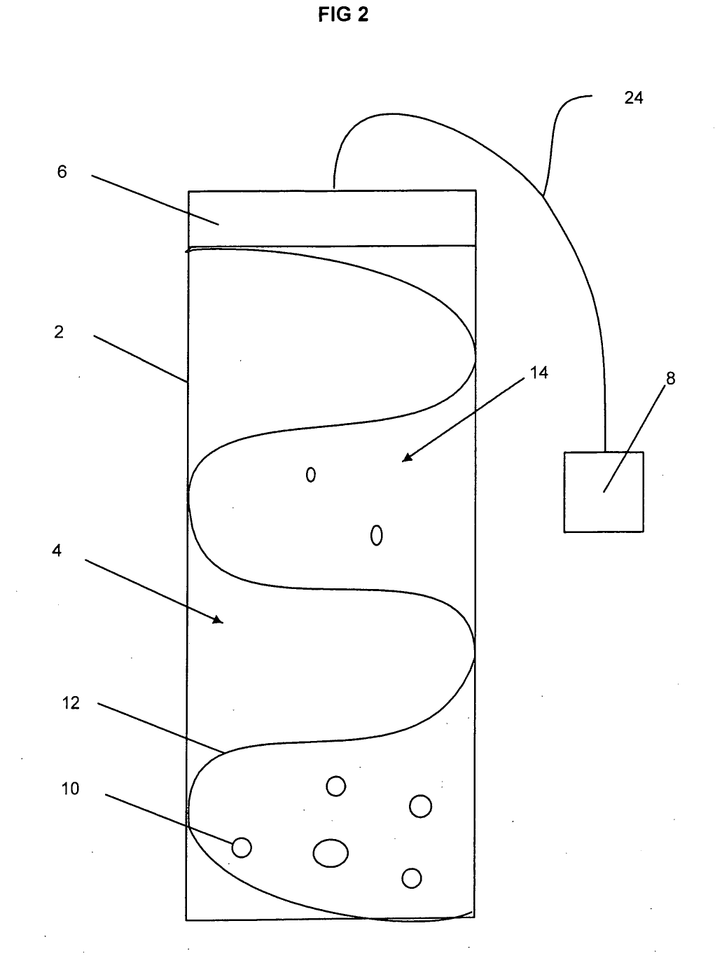

More features of the electro-mechanical system are shown in FIG. 2, including a container 2 enclosing a fluid mixture 4 containing particles 10. A transducer 6 positioned at one end of the container creates a standing wave 12 within the fluid mixture 4 that extends axially along the length of the container 2. The standing wave separates the particles 10 into regions 14 within the fluid mixture 4.

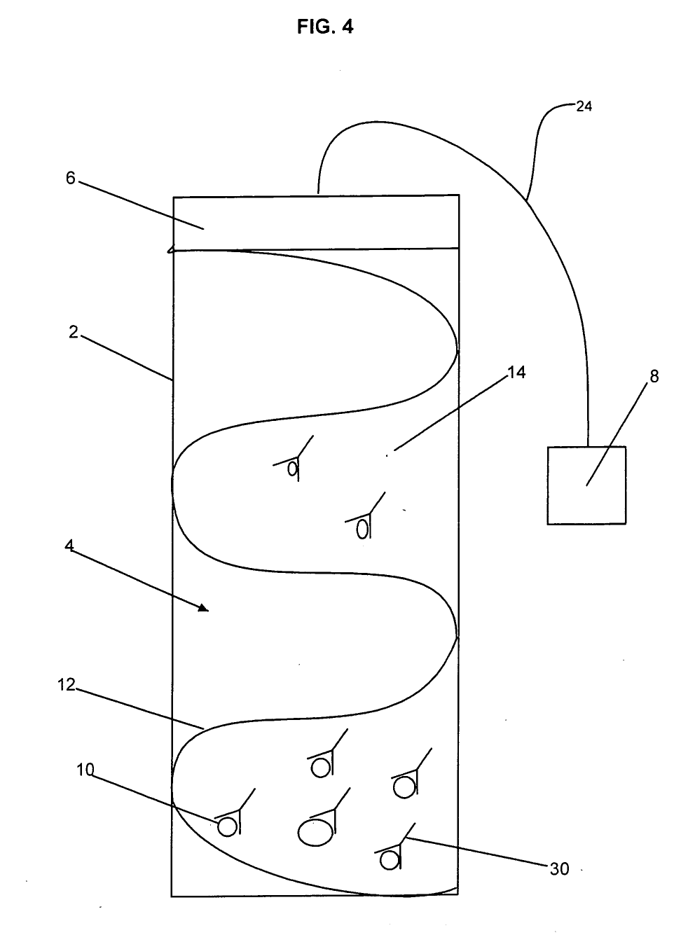

Also depicted in FIG. 2 is an electrical controller 8 coupled through a conduit 24 to the transducer 6. In various embodiments, the wave 12 within the container 2 may be either a standing or a traveling wave. The wave 12 may be any one of a number of types, including magnetic, pressure or electrostatic waves. The type and properties of the wave may be selected in order to best separate the particles in any given application based on the physical characteristics of the particles, or various types of particles, the physical characteristics of any material bound to the particles as shown in FIG. 4 or the physical characteristics of the composite of the bound material and the particles. The wave may be oriented axially or in any other direction relative to the container.

In some embodiments, the wave may be altered during the course of the separation process in order to adaptively separate the particular particles or composites within a particular fluid mixture. There may also be a plurality of waves generated by multiple transducers or a combination of transducers and reflectors.

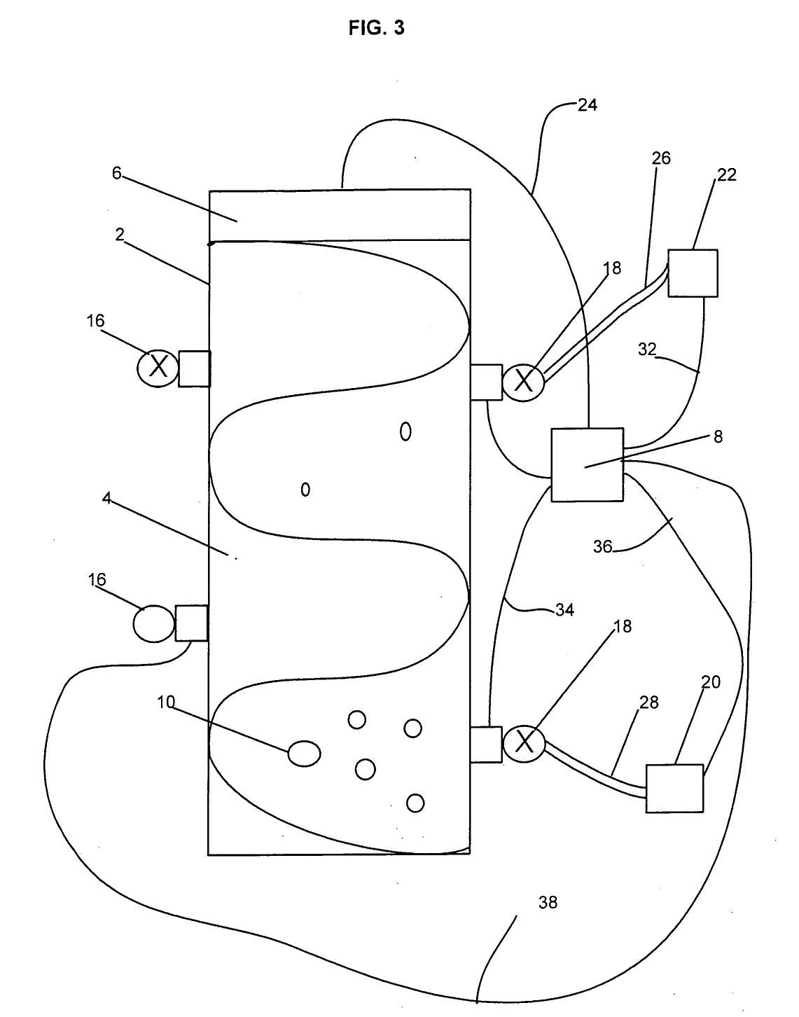

Additional features of the electro-mechanical system are depicted in FIG. 3. The container 2 is shown enclosing a fluid mixture 4 containing particles 10 which are being separated by a wave 12 within the container 2. FIG. 3 depicts a standing wave 12, however the wave may also be a traveling wave and may be of any type including acoustic or pressure. The transducer 6 is coupled through conduit 24 to an electrical controller 8. Also attached to the container 2 is at least one inlet port 16 capable of admitting additional mixture components or fluid into the container. In some embodiments, there are one or more inlet ports allowing the addition of additional fluid or mixture components to the container, while in other embodiments the container may be opened to add additional fluid or components or the material from which the container is constructed may be permeable to allow additional fluid or mixture components to enter the container through the enclosure boundary. In other embodiments, no additional fluid or components are added to the container. The inlet port or ports 16 is coupled through conduit 38 to the electrical controller 8.

Another feature depicted in FIG. 3 is at least one outlet port 18 attached to the container 2 and configured to allow the exit of spatially distributed particles from the container. In some embodiments, there are one or more outlet ports while in others the container is permeable in selected locations to allow the exit of separated particles. In still another approach, the container may be opened to remove to separated particles. In other embodiments, the separated particles are not removed from the container. The outlet port or ports 18 are coupled through conduit 34 to the electrical controller 8. Material exiting the container 2 may be directed through conduit 26 to an attached collection device 22 or directed through conduit 28 to a sensor device 20 or to both of these devices in series in any order and combination.

The collection device 22 and the sensor device 20 are coupled through conduits 32 and 36 to the electrical controller 8. In some embodiments, data regarding the physical characteristics or quantity of the material exiting the container via the outlet ports 18 may be transmitted from the collection 22 or sensor 20 device or devices to an electrical controller 8. This data may then be the basis of modifications to the wave action 12 within the container 2.

Other features of the electro-mechanical system as depicted in FIG. 4 include a container 2 enclosing a fluid mixture 4 containing particles 10. Attached to the container is at least one transducer 6 which is coupled through conduit 24 to an electrical controller 8. In some embodiments, a binding material 30 is attached to the particles 10 and the composite of binding material 30 and particles 10 are separated by the wave 12 within the container 2. The binding material may be either organic or inorganic and of any type or combination, including antibodies, proteins, chemicals, metals or plastics. The binding material may be attached to the particles by any means known in the art, including physical enclosure, electrostatic attraction, and covalent or non-covalent bonding. In some embodiments, the composite of the binding material and the particles may be in a one to one ratio and in other embodiments there may be more than one unit of the binding material attached to a given particle or more than one particle bound to each unit of binding material. The binding material and particles may also form complexes including multiple units of each. In some embodiments, the binding material may be composed of a group of subparts which may be organic or inorganic. The wave function which separates the particles and the binding material from the fluid mixture may be of a type that separates the particles, the binding material or a composite or complex of these.

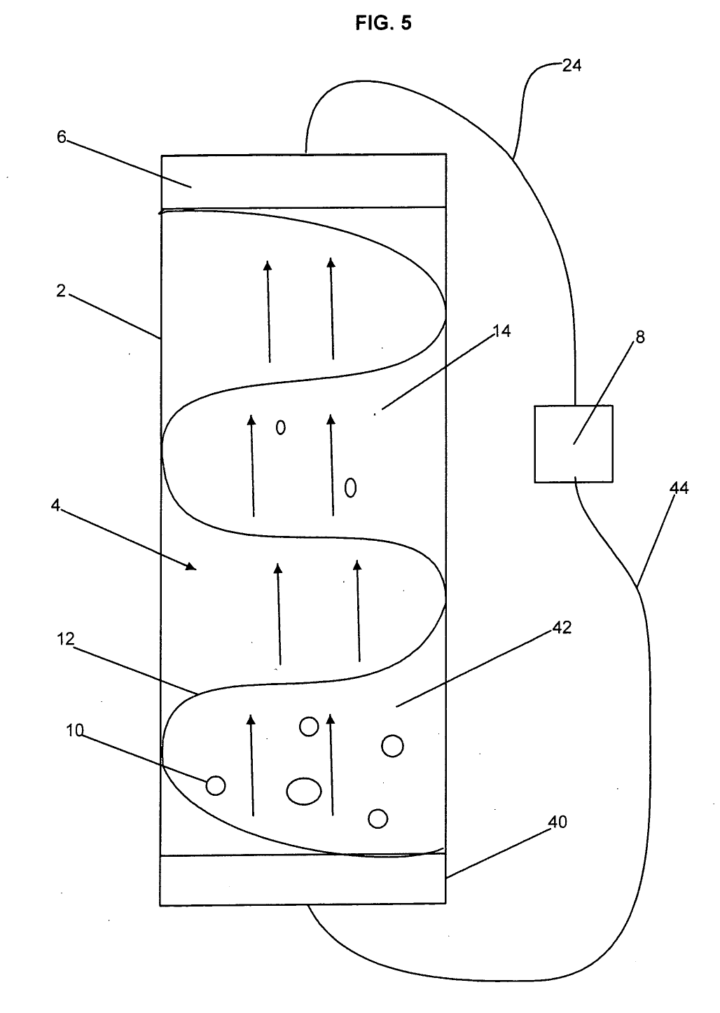

As depicted in a simplified format in FIG. 5, another feature of the electro-mechanical system is at least one gradient generator 40 attached to the container 2 and operable to create a gradient driver 42. As depicted in FIG. 5, the gradient driver 42 produced by the gradient generator 40 is distinct from the wave 12 produced by the transducer 6. The gradient driver may be of any type, including an electrical, magnetic or acoustic field or an optical or thermal gradient and may be at any angle relative to the first wave. In addition, the gradient created by the gradient driver may be a linear or nonlinear gradient. In some embodiments, the wave type produced by a gradient generator is of the same type as the wave generated by the transducer while in other embodiments they are of different types. For example, the transducer may create a pressure wave while the gradient driver creates an optical gradient or the transducer may create a magnetic wave while the gradient driver creates a pressure wave. In the embodiment depicted in FIG. 5, the gradient driver is coupled to the electrical controller 8 through a conduit 44.

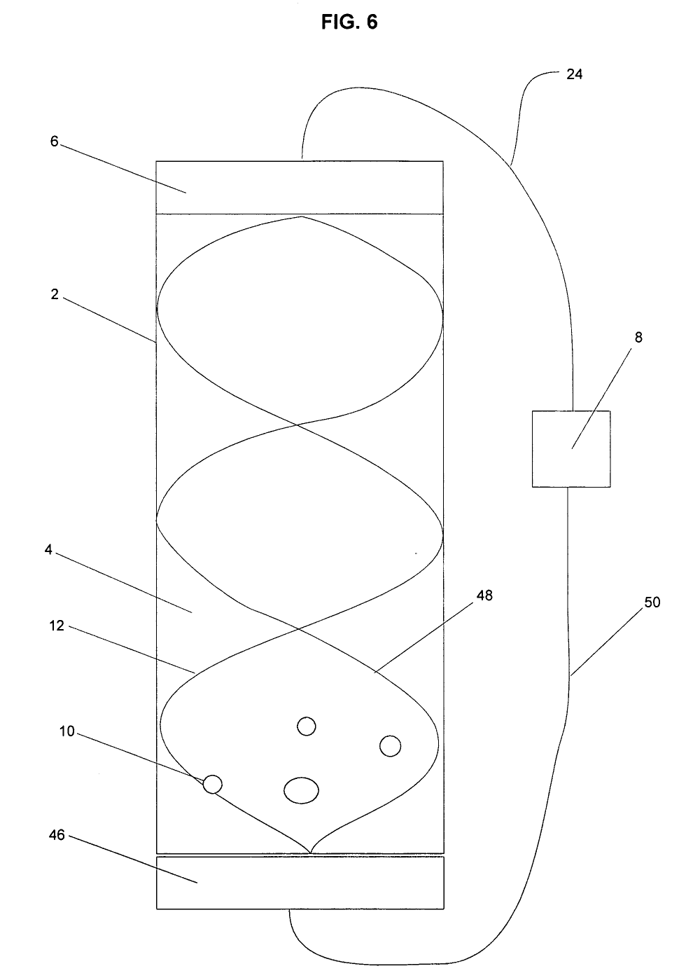

FIG. 6 depicts more features of the system, including a second transducer 46 attached to the container 2. There may be a plurality of transducers attached to the container to create any wave pattern in a given embodiment, although only two transducers are represented in FIG. 6. In some embodiments, there may also be one or more reflectors at any location relative to the transducer(s) to reflect the wave or waves and contribute to the wave function within the container. As depicted in FIG. 6, the second transducer may create a second wave 48 which forms a standing wave in conjunction with the wave 12 created by the first transducer 6. This standing wave acts to separate the particles 10 within the fluid mixture 4. Although a simplified standing wave created by two transducers is depicted in FIG. 6, the wave pattern may be complex and generated by a plurality of transducers and reflectors to form any wave pattern. In some embodiments the wave or waves are standing waves while in other embodiments the wave or waves are traveling or a combination of standing and traveling. In some embodiments the waves may also be of different types, for example a combination of pressure and magnetic waves or a combination of a thermal gradient and an acoustic wave. As depicted in the embodiment shown in FIG. 6, all transducers may be coupled to the electronic controller 8 through conduits 24, 50.

Another aspect is the method of separating particles from a fluid mixture by means of a wave action within the fluid where the wave action is controlled by an attached device. The wave may be either a standing or a traveling wave and may be of any type that produces a spatial distribution of the particles, including an acoustic, fluid, or pressure wave. The particles may be of any type or combination, including organic, inorganic, chemical, metallic or biological, or a combination of any number or type of these. If the particles are biological, they may be proteins, nucleic acids, lipids, saccharides, cells, or viruses, or a combination of biological particles or biological and non-biological particles. In some embodiments, the wave action is a function of the specific gravity of the separated particles. An additional feature of this exemplary method is the addition of binding material to the fluid mixture to form composites with the material to be separated and using a physical characteristic of the binding material, particles or the composite to separate the composite with a wave action through the fluid mixture.

Another feature of the exemplary method is the addition of a gradient driver to further separate the particles, where the gradient driver may be linear or nonlinear and of any type, including a magnetic field, electric field, acoustic wave, or an optical or thermal gradient. The gradient driver may be applied at a variety of angles relative to the primary wave action, depending upon the desired separation characteristics.

Another aspect of the method is the addition of more fluid or additional components to the fluid during the separation process. Other features of the method are the removal of separated particles during the separation process and the detection of a physical characteristic of the separated material after it is removed. In addition, the wave action or the addition of additional components or fluid to the container may be modified based on the quantity or a detected physical characteristic of the separated particles. The separated material may be collected and stored in one or multiple units, and this collection may occur after the particles are separated or after a physical characteristic of the separated particles has been detected.

In one embodiment, the particles to be separated are proteins specifically recognized by an antibody which has been conjugated to a compound or other material of known size so that the protein-antibody-compound composite has a predicted mass that is significantly larger than that of the protein alone. If the fluid mixture contains this composite, a physical wave may be generated within the container to separate the composite from other particles of different mass. In some embodiments, the fluid mixture contains cells of varying mass. A pressure wave may be generated by the transducer in order to separate these cells based on their distinctive mass. In addition, additional cells may be added to the container though the inlet ports or cells may be removed from the container through the outlet ports before, during or after the separation process. Physical characteristics such as quantity, size, mass and color of the cells exiting the container may also be quantified by a sensor device attached to the outlet port. A collection device may also be attached to the outlet port or to the sensor device. In some embodiments, cells leaving the container through the outlet port would be characterized by an attached flow cytometer and then cells with desired characteristics would be collected in individual tubes. One skilled in the art would appreciate that this embodiment could be used to separate sperm cells containing chromosomes of differing sizes for the purposes of specific sex selection during assisted fertilization for animal husbandry or to separate cancer cells from normal cells in a medical specimen. In other embodiments, a collection device attached to the outlet port would place the separated particles into multiple tubes. In some embodiments, one or more distinct biotherapeutic particles, which may include proteins, lipids or saccharides, may be purified from a mixture during the manufacture of biotherapeutic compounds on the basis of size, mass, or charge, possibly after having formed a composite complex with a specific antibody, compound or other material.

In a general sense, those skilled in the art will recognize that the various embodiments described herein can be implemented, individually and/or collectively, by various types of electro-mechanical systems having a wide range of electrical components such as hardware, software, firmware, or virtually any combination thereof; and a wide range of components that may impart mechanical force or motion such as rigid bodies, spring or torsional bodies, hydraulics, and electro-magnetically actuated devices, or virtually any combination thereof. Consequently, as used herein “electro-mechanical system” includes, but is not limited to, electrical circuitry operably coupled with a transducer (e.g., an actuator, a motor, a piezoelectric crystal, etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), electrical circuitry forming a communications device (e.g., a modem, communications switch, or optical-electrical equipment), and any non-electrical analog thereto, such as optical or other analogs. Those skilled in the art will also appreciate that examples of electro-mechanical systems include but are not limited to a variety of consumer electronics systems, as well as other systems such as motorized transport systems, factory automation systems, security systems, and communication/computing systems. Those skilled in the art will recognize that electro-mechanical as used herein is not necessarily limited to a system that has both electrical and mechanical actuation except as context may dictate otherwise.

In many of the exemplary embodiments shown, the particle is a biological particle. However the methods and systems described herein may be applied to many other types of particles, such as metallic materials, organic materials, or any other appropriate types of particles. It will also be appreciated that, although specific embodiments have been described herein for purposes of illustration, various modifications may be made without deviating from the spirit and scope of the invention. For example, methods, devices, and systems described herein could be used for various medical applications such as to remove components from blood, urine, saliva or other bodily fluids for the purpose of medical testing on the separated components. Alternatively, the approaches described herein may be applied in a variety of non-medical applications, including isolating or extracting selected materials such as heavy metals from mixtures. Thus the scope of the invention should be determined by the appended claims and their legal equivalent rather than by the described embodiments.

What is claimed is:

1-71. (canceled)

72. An apparatus for separating biological particles from a fluid mix, comprising:
a container configured to at least partially enclose the fluid mix;
an electrical controller including circuitry for producing a driving signal;
at least one transducer responsive to the driving signal, the transducer being coupled to the container and operable to produce waves within the fluid mix, the waves having wavelength and amplitude selected to interact with the biological particles in a manner that produces a selected spatial distribution of the particles within the container;
one or more spaced apart outlet ports configured to permit exit of at least a portion of the fluid mix;
one or more sensor devices positioned to monitor the at least a portion of the fluid mix exiting the one or more spaced apart outlet ports and operative to transmit data indicative of at least one characteristic of one or more biological particles in the exiting at least a portion of the fluid mix; and
wherein the electrical controller is responsive to the transmitted data to adjust the control signal.

73. The apparatus of claim 72, comprising:
a plurality of transducers, said transducers of a type capable of creating the same or different types of waves within the container.

74. The apparatus of claim 72, comprising:
one or more spaced apart inlet ports configured to admit fluid into the container.

75. The apparatus of claim 72, comprising:
one or more spaced apart inlet ports configured to admit additional components to the fluid.

76. The apparatus of claim 72, wherein the at least one transducer of a type that creates either a magnetic or pressure wave.

77. The apparatus of claim 72, wherein the at least one transducer of a type that creates a standing wave.

78. The apparatus of claim 72, comprising:
a gradient generator configured to produce a gradient driver in the fluid mix.

79. The apparatus of claim 72, wherein the container includes at least one permeable region configured to allow some components of the fluid mixture to enter a container enclosure boundary.

80. The apparatus of claim 72, wherein the container includes at least one permeable region configured to allow some components of the fluid mixture to exit a container enclosure boundary.

81. The apparatus of claim 72, wherein the fluid mix contains cells of varying mass.

82. The apparatus of claim 72, wherein the biological particles are nucleic acids.

83. The apparatus of claim 72, wherein the biological particles are antibodies.

84. The apparatus of claim 72, wherein the biological particles include:
conductive molecules and non-conductive molecules.

85. The apparatus of claim 72, wherein the container encloses the fluid mix within a larger structure.

86. The apparatus of claim 72, wherein the fluid mix includes at least one bodily fluid.

87. The apparatus of claim 72, wherein one or more of the at least one transducer is a piezoelectric transducer.

88. An apparatus for separating biological particles from a fluid mix, wherein the fluid mix also includes material bound to the biological particles to form a composite, comprising:
a container configured to at least partially enclose the fluid mix;
an electrical controller including circuitry for producing a driving signal;
at least one transducer responsive to the driving signal, the transducer being coupled to the container and operable to produce waves within the fluid mix, the waves having wavelength and amplitude selected to interact with the composite in a manner that produces a selected spatial distribution of the composite within the container;
one or more spaced apart outlet ports configured to permit exit of at least a portion of the fluid mix;
one or more sensor devices positioned to monitor the at least a portion of the fluid mix exiting the one or more spaced apart outlet ports and of a type operative to transmit data indicative of at least one characteristic of one or more biological particles in the exiting at least a portion of the fluid mix; and
wherein the electrical controller is responsive to the transmitted data to adjust the control signal.

89. The apparatus of claim 88, comprising:
one or more spaced apart inlet ports configured to admit fluid into the container.

90. The apparatus of claim 88, comprising:
one or more spaced apart inlet ports configured to admit additional components to the fluid.

91. The apparatus of claim 88, wherein the at least one transducer is of a type that creates either a magnetic or pressure wave.

92. The apparatus of claim 88, wherein the at least one transducer is of a type that creates a traveling wave.

93. The apparatus of claim 88, comprising:
a gradient generator configured to produce a gradient driver in the fluid mix.

94. The apparatus of claim 88, wherein the gradient driver is an electric or magnetic field, a pressure or acoustic wave or an optical or thermal gradient.

95. The apparatus of claim 88, wherein the container includes at least one permeable region configured to allow some components of the fluid mixture to enter a container enclosure boundary.

96. The apparatus of claim 88, wherein the container includes at least one permeable region configured to allow some components of the fluid mixture to exit a container enclosure boundary.

97. The apparatus of claim 88, wherein the fluid mix contains cells of varying mass.

98. The apparatus of claim 88, wherein the biological particles are proteins.

99. The apparatus of claim 88, wherein the biological particles are nucleic acids.

100. The apparatus of claim 88, wherein the biological particles are antibodies.

101. The apparatus of claim 88, wherein the biological particles include:
conductive molecules and non-conductive molecules.

102. The apparatus of claim 88, wherein the container encloses the fluid mix within a larger structure.

103. The apparatus of claim 88, wherein the fluid mix includes at least one bodily fluid.

104. The apparatus of claim 88, wherein one or more of the at least one transducer is a piezoelectric transducer.

105. An apparatus for separating biological particles from a fluid mix, comprising:
an electrical controller including circuitry for producing a driving signal;
at least one transducer responsive to the driving signal, the transducer of a type capable of being coupled to a container and operable to produce waves within the fluid mix, the waves having wavelength and amplitude selected to interact with the biological particles in a manner that produces a selected spatial distribution of the particles within the container;
one or more spaced apart outlet ports configured to permit exit of at least a portion of the fluid mix;
one or more sensor devices coupled to each of the one or more spaced apart outlet ports, the one or more sensor devices positioned to monitor the at least a portion of the fluid mix exiting the one or more spaced apart outlet ports and operative to transmit data indicative of at least one characteristic of one or more biological particles in the exiting at least a portion of the fluid mix;
wherein the electrical controller is responsive to the transmitted data to adjust the control signal; and
at least one collection device coupled to one or more of the outlet ports.

106. The apparatus of claim 105, wherein the one or more sensor devices includes at least one flow cytometer.

107. The apparatus of claim 105, comprising:
a plurality of transducers, said transducers of a type capable of creating the same or different types of waves within the container.

108. The apparatus of claim 105, comprising:
one or more spaced apart inlet ports configured to admit fluid into the container.

109. The apparatus of claim 105, comprising:
one or more spaced apart inlet ports configured to admit additional components to the fluid.

110. The apparatus of claim 105, wherein the at least one transducer is of a type that creates either a magnetic or pressure wave.

111. The apparatus of claim 105, wherein the at least one transducer is of a type that creates a standing wave.

112. The apparatus of claim 105, wherein the at least one transducer is of type that creates a traveling wave.

113. The apparatus of claim 105, comprising:
a gradient generator configured to produce a gradient driver in the fluid mix.

114. The apparatus of claim 105, wherein the gradient driver is an electric or magnetic field, a pressure or acoustic wave or an optical or thermal gradient.

115. The apparatus of claim 105, comprising:
a container including at least one permeable region configured to allow some components of the fluid mixture to enter the container enclosure boundary.

116. The apparatus of claim 105, comprising:
a container including at least one permeable region configured to allow some components of the fluid mixture to exit the container enclosure boundary.

117. The apparatus of claim 105, wherein the fluid mix contains cells of varying mass.

118. The apparatus of claim 105, wherein the biological particles are proteins.

119. The apparatus of claim 105, wherein the biological particles are nucleic acids.

120. The apparatus of claim 105, wherein the biological particles are antibodies.

121. The apparatus of claim 105, wherein the biological particles include:
conductive molecules and non-conductive molecules.

122. The apparatus of claim 105, comprising:
a container of a type that encloses the fluid mix within a larger structure.

123. The apparatus of claim 105, wherein the fluid mix includes at least one bodily fluid.

124. The apparatus of claim 105, wherein one or more of the at least one transducer is a piezoelectric transducer.
